(19) United States
(12) Patent Application Publication
(10) Pub. No.: US 2025/0327430 A1
(43) Pub. Date: Oct. 23, 2025

(54) AIRCRAFT PROPULSION SYSTEM AND THRUST REVERSER MECHANISM

(71) Applicant: MRA Systems LLC, Baltimore, MD (US)

(72) Inventors: Timothy BEASMAN, Baldwin, MD (US); Jeffrey KOWALEC, Harwinton, CT (US)

(73) Assignee: MRA Systems LLC, Baltimore, MD (US)

(21) Appl. No.: 19/183,268

(22) Filed: Apr. 18, 2025

Related U.S. Application Data
(60) Provisional application No. 63/636,265, filed on Apr. 19, 2024.

(51) Int. Cl. F02K 1/76; B64D 29/06

(52) U.S. Cl. CPC F02K 1/766; B64D 29/06

(57) ABSTRACT

An aircraft propulsion system includes an engine assembly including a fan that rotates to move air to create thrust, and a cowl that surrounds at least a portion of the engine assembly. The cowl includes an outer surface arranged away from the engine assembly that provides an aerodynamic surface. The aircraft propulsion system also includes a thrust reverser mechanism connected to the cowl and configured to change a direction of the thrust while in a reverse position. The thrust reverser includes a blocking door and blocking door hinge. The blocking door is connected to the blocking door hinge, and the blocking door is configured to pivot around a hinge line between a forward position and the reverse position. The blocking door hinge includes a hinge bolt that is misaligned with the hinge line.

### FIELD OF THE INVENTION

The present disclosure relates generally to an aircraft propulsion system, and in particular, a mechanism for opening and closing a thrust reverser included in the aircraft propulsion system.

### BACKGROUND OF INVENTION

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

Aircraft propulsion systems include one or more engines with a rotating fan and a nacelle cowling structure surrounding at least a portion of the fan. As shown in FIGS. 7A and 7B, a short duct 3908 (FIG. 7A), separated flow type nacelle 3900 and a long duct 3908 (FIG. 7B), mixed flow nacelle 3914 each include an inlet 3902 at a front end, fan cowls 3904 arranged aft of the inlet 3902, and a ducted cowl 3906 (including fan ducts 3908), which may include a thrust reversal mechanism such as a thrust reverser, aft of the fan cowls 3904. The nacelle structure wraps around the engine 3912 to provide external surfaces that protect engine components (e.g., engine electrical components) from the environment and reduce aerodynamic drag. The aircraft propulsion system is supported by a pylon 3910. The ducted cowl 3906 provides internal ducting to efficiently guide air to provide forward thrust during normal flight operation and in some cases may contain a reversing mechanism (e.g., thrust reversal mechanism or thrust reverser) to redirect airflow to slow the aircraft during landing.

FIG. 6A shows the side view and cross section location for a conventional thrust reversing mechanism for comparison purposes. FIG. 6b is the cross section of a conventional thrust reverser at the cross section location, with pivoting blocker doors (aka, pivot doors, blocker doors, or rotating blocker doors) 64 and 65 and with the hinge pin 60 aligned with the hinge axis 61. The door hinge pin 60 passes through the fixed structure 67, which is attached to the engine nozzle 3906. With the hinge pin 60 aligned to the hinge axis 61, a bump up, or blister fairing 62, is required on the inner duct flow surface 63. Such a bump up or blister fairing 62 is disadvantageous because it distorts the inner flow surface 63 to be different than an ideal aerodynamic surface 66.

### SUMMARY OF INVENTION

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure. An embodiment of the invention may include an aircraft propulsion system having an engine assembly including a fan that rotates to move air to create thrust; a cowl that surrounds at least a portion of the engine assembly, the cowl including an outer surface arranged away from the engine assembly that provides an aerodynamic surface; and a thrust reverser connected to the cowl and configured to change a direction of the thrust while in a reverse position, wherein the thrust reverser includes a blocker door and blocker door hinge, the blocker door is connected to the blocker door hinge, and the blocker door is configured to pivot around a hinge line between a forward position and the reverse position, and the blocker door hinge includes a hinge bolt that is misaligned with the hinge line.

The embodiment may further include the aircraft propulsion system, wherein the blocker door hinge includes a spherical joint.

The embodiment may further include the aircraft propulsion system, wherein the blocker door hinge includes a ball joint.

The embodiment may further include the aircraft propulsion system, wherein the blocker door hinge includes a gimbal joint.

The embodiment may further include the aircraft propulsion system, wherein the blocker door hinge includes a joint configured to rotate the blocker door along a path that is not perpendicular to the hinge bolt.

The embodiment may further include the aircraft propulsion system, wherein: the blocker door is connected to the hinge bolt; and the hinge bolt is configured to pivot around the hinge line.

The embodiment may further include the aircraft propulsion system, wherein: the hinge bolt is arranged entirely within a tangent across an outer surface of the cowl aerodynamic surface.

The embodiment may further include the aircraft propulsion system, wherein the hinge line is arranged above an engine center line and perpendicular to a direction of engine thrust.

The embodiment may further include the aircraft propulsion system, wherein the blocker door has a distal end/leading edge that is arranged perpendicular to the thrust direction.

The embodiment may further include the aircraft propulsion system, wherein the cowl includes a nozzle and the thrust reverser is included in the nozzle.

The embodiment of the aircraft propulsion system may also include a controllable actuator that causes the pivot door to be rotated away from a central axis of the engine to be in the reverse position.

### BRIEF DESCRIPTION OF THE DRAWINGS

The scope of the present disclosure is best understood from the following detailed description of exemplary embodiments when read in conjunction with the accompanying drawings, wherein:

FIG. 1 is an isometric view of a cowl assembly with open blocker doors (i.e., reverse mode) according to an embodiment of the invention;

FIGS. 2A and 2B show side views of an embodiment of a cowl assembly with thrust reverser in closed position (i.e., forward mode) (FIG. 2A) and open positions (i.e., reverse mode) (FIG. 2B);

FIGS. 3A and 3B show isometric views of an embodiment of a cowl assembly with thrust reverser in reverse mode (FIG. 3A) and forward mode (FIG. 3B);

FIG. 4A is a forward looking aft (FLA) view of an embodiment with cowl in “forward mode”;

FIG. 4B is an FLA view of an embodiment with the reverser in “reverse mode”;

FIG. 4C is an aft looking forward (ALF) view of an embodiment in “reverse mode”;

FIG. 5A is a side view of an embodiment showing a location of the cross section view through the hinge point;

FIG. 5B is a cross section view of an embodiment through the hinge joint, showing fixed and moveable portions of the structure, spherical bearing, and Door Hinge Axis;

FIG. 6A is a comparative example of a side view of a conventional pivot door hinge showing the cross section location for pivot door hinge installation, that does not include a spherical bearing according to the invention;

FIG. 6B is a cross sectional view of the comparative example in FIG. 6A;

FIG. 7A is a side view of a conventional aircraft propulsion system; and

FIG. 7B is a side view of a conventional aircraft propulsion system.

Further areas of applicability of the present disclosure will become apparent from the detailed description provided hereinafter. It should be understood that the detailed description of exemplary embodiments is intended for illustration purposes only and are, therefore, not intended to necessarily limit the scope of the disclosure.

### DETAILED DESCRIPTION

An aircraft propulsion system may include an engine assembly including a fan that rotates to move air; a cowl that surrounds at least a portion of the engine assembly when the cowl is in a closed position, the cowl including an outer surface arranged away from the engine assembly that provides an aerodynamic surface. The cowl may include a thrust reverser.

The thrust reverser includes one or more moveable panels and blocker doors. The thrust reverser is configured to be translatable between a normal operating mode and a reverse operating mode. In the normal operating mode, moveable panels and blocker doors are arranged so that engine thrust propels the aircraft in a forward direction. In the reverse operating mode, redirect engine thrust in a reverse direction.

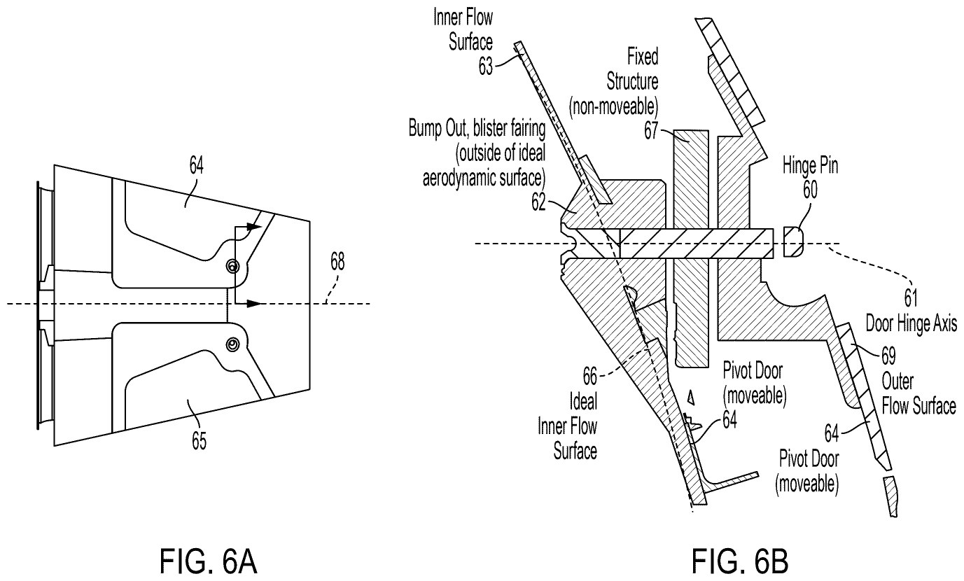

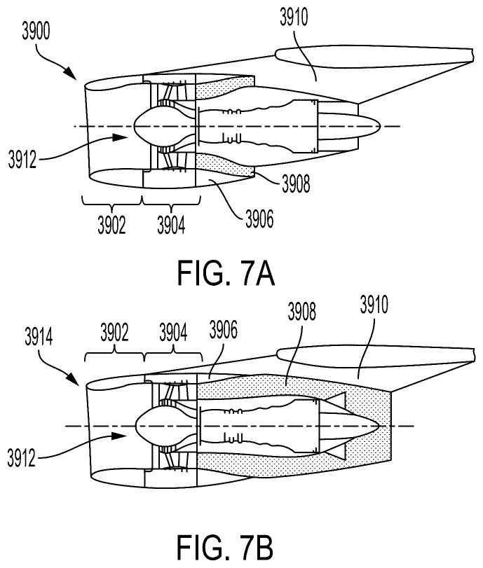

In a conventional thrust reverser, as shown in FIGS. 6A and 6B, a hinge joint, which allows blocker door rotation, has a hinge pin 60 aligned with the hinge line 61 (aka, door hinge axis) that allows blocker rotation. The hinge line 61 is a line along which a blocker door may rotate. The hinge line 61 is in an aft portion of the nozzle, both above and below the engine centerline 68. The use of such a bolted joint aligned with the hinge line 61 in the conventional thrust reverser may extend close to, or beyond, an ideal outer aerodynamic flow surface line 66 of the cowl. Thus, a conventional thrust reverser may require a “bump out” or “blister” feature 62 to be added to an inner flow surface 63 of the cowl, such that the shape of the cowl deviates from an ideal flow surface shape. Such a “bump out” or “blister” may result in disadvantageous aerodynamics (and resulting performance) and aesthetics.

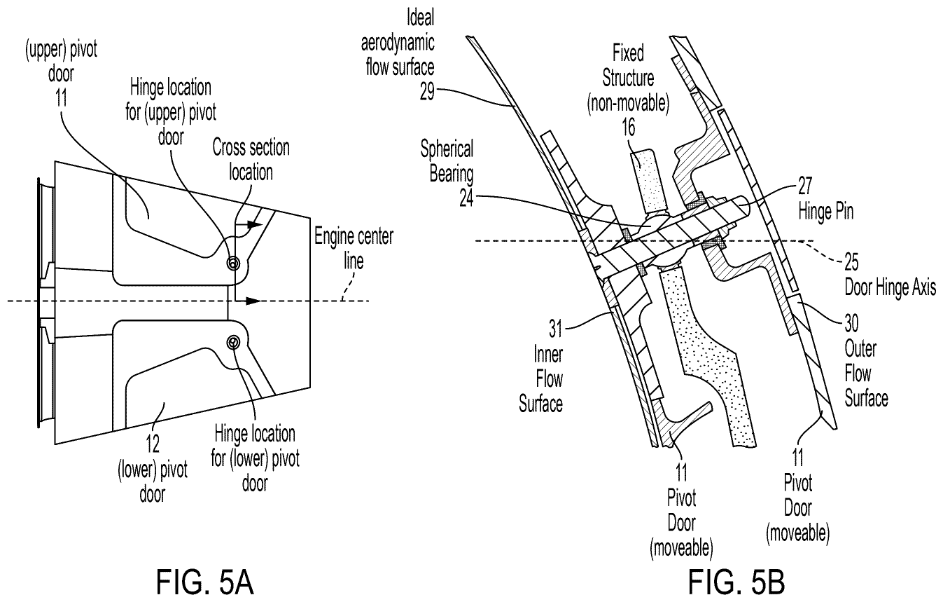

To avoid problems associated with the conventional thrust reverser, a thrust reverser mechanism according to the present invention, as shown in FIGS. 5A and 5B, includes a blocker door hinge (aka, hinge joint) having a spherical bearing 24 at each connection between a blocker door 11/12 and the engine. According to such an improvement, the door hinge axis 25 of the hinge pin 27 (aka, hinge bolt) does not need to be aligned with the door hinge axis 23, and therefore, the hinge pin 27 can be oriented to fit entirely within the ideal aerodynamic flow surface 29 of the outer cowl.

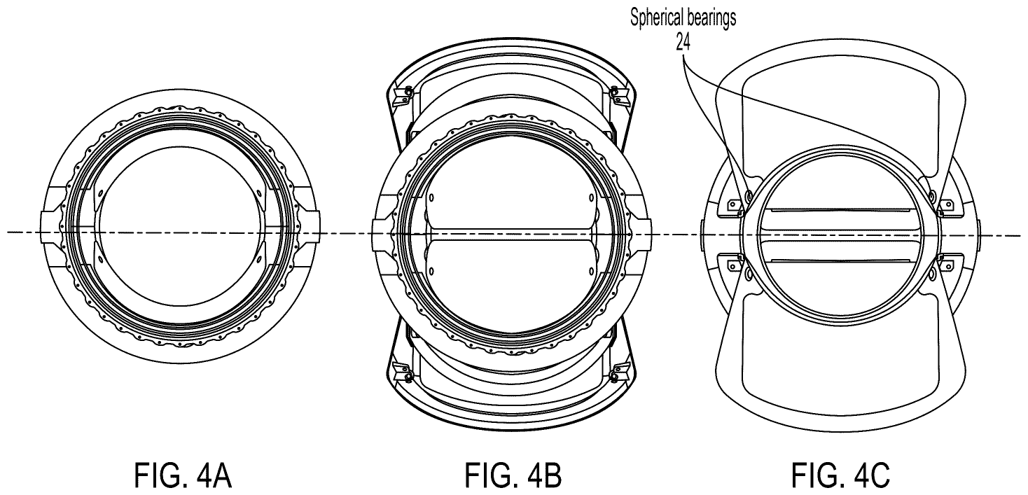

Using a spherical bearing 24 at the pivoting joint of the blocker door hinge (i.e., around the hinge pin 27) creates a virtual hinge line along the door hinge axis 25 through a center of the spherical bearing. Each blocker door 64 includes two spherical bearings 24 (e.g., as shown in FIG. 4C). The spherical bearing 24 allows for the axis of hinge pin 27 to be oriented to make better use of the packaging space without requiring a bump out or blister. This allows for tighter packaging of the hinge joint, eliminating or reducing the need for bump outs or blisters to be added to the flow surfaces, reducing the impacts on engine performance.

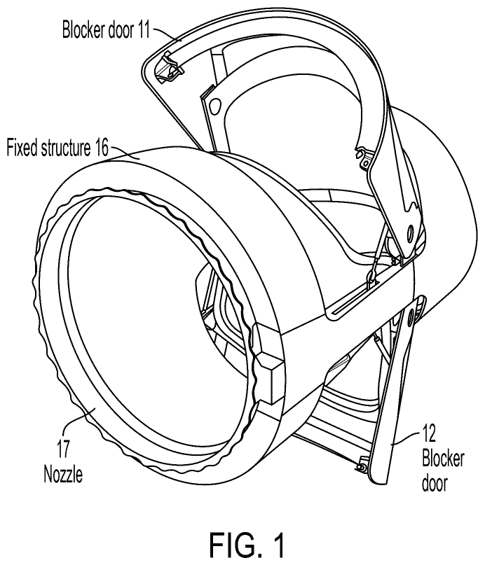

FIG. 1 shows an isometric view of an embodiment of the blocker door hinge with the thrust reversing blocker doors 11 and 12 deployed (i.e., in a reverse mode, aka open position). The fixed structure 16 is the “non moveable” portion of the nozzle 17, and provides a structure for mounting the blocker doors 11 and 12 via an embodiment of the hinge joint. The blocker doors 11 and 12 are the moveable structures that block and reverse the flow of air when deployed. The blocker door hinge (aka, pivot point) is a rotating joint that allows movement of the blocker doors 11 and 12 relative to the fixed structure 16. The hinge pin 27 is arranged along a different direction (i.e., misaligned) from the door hinge axis 25 (i.e., hinge line). The blocking door positions may be changed by an attached actuator, such as a linear actuator or jack screw, for example.

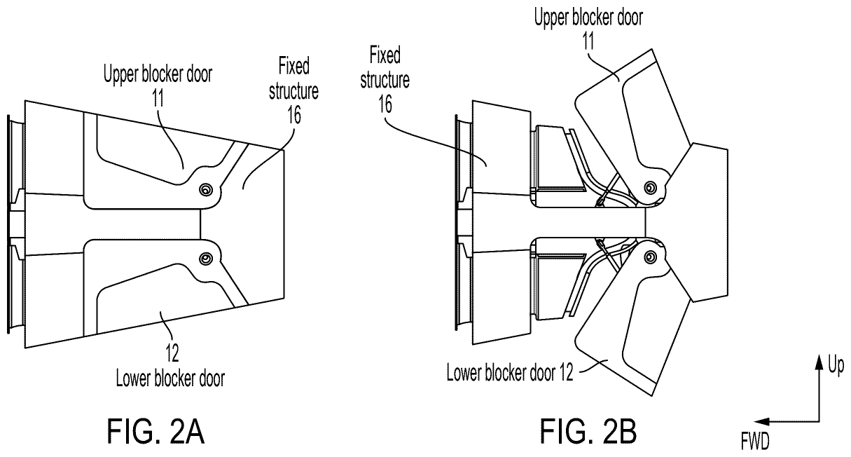

FIGS. 2A and 2B provide a side view showing the blocking doors in closed position (aka, forward thrust mode) in FIG. 2A, and in open position (aka, reverse thrust mode) in FIG. 2, according to an embodiment of the invention.

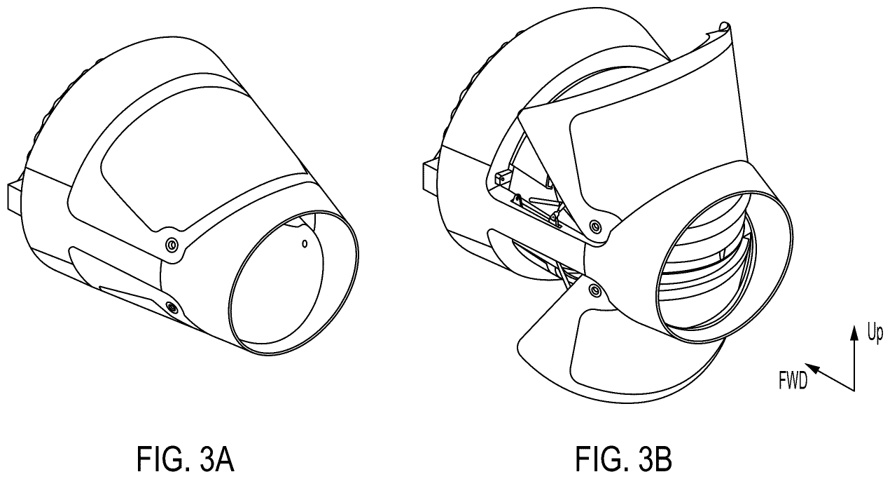

FIGS. 3A and 3B are additional views of the reverser in forward (i.e., closed position) in FIG. 3A and reverse mode (i.e., open position) in FIG. 3B.

FIGS. 4A and 4B show a forward looking aft view with reverser in forward mode and (FIG. 4A) and reverse mode (FIG. 4B). FIG. 4C shows the aft looking forward view in reverse mode.

FIG. 5A shows the side view and cross section location of the embodiment. FIG. 5B shows a cross section view though the cross section location. The spherical bearing 24, allows the hinge pin 27 to be off axis of (i.e., misaligned with) the door hinge axis 25. Having the hinge pin 27 off axis allows for the hinge pin 27 to be aligned “normal” (i.e., perpendicular) to the outer flow surface 30 and the inner flow surface 31 rather than aligned with the door hinge axis 25. This allows better packaging of the joint. Alternatively, according to the invention, the spherical joint 24 may be replaced with a ball joint, a gimbal joint, or any joint configured to rotate the blocker doors along a path that is not perpendicular to the hinge bolt.

What is claimed is:

1. An aircraft propulsion system comprising:
an engine assembly including a fan that rotates to move air to create thrust;
a cowl that surrounds at least a portion of the engine assembly, the cowl including an outer surface arranged away from the engine assembly that provides an aerodynamic surface; and
a thrust reverser connected to the cowl and configured to change a direction of the thrust while in a reverse position,
wherein
the thrust reverser includes a blocker door and blocker door hinge, the blocker door is connected to the blocker door hinge, and the blocker door is configured to pivot around a hinge line between a forward position and the reverse position, and
the blocker door hinge includes a hinge bolt that is misaligned with the hinge line.

2. The aircraft propulsion system according to claim 1, wherein the blocker door hinge includes a spherical joint.

3. The aircraft propulsion system according to claim 1, wherein the blocker door hinge includes a ball joint.

4. The aircraft propulsion system according to claim 1, wherein the blocker door hinge includes a gimbal joint.

5. The aircraft propulsion system according to claim 1, wherein the blocker door hinge includes a joint configured to rotate the blocker door along a path that is not perpendicular to the hinge bolt.

6. The aircraft propulsion system according to claim 1, wherein:
the blocker door is connected to the hinge bolt; and
the hinge bolt is configured to pivot around the hinge line.

7. The aircraft propulsion system according to claim 1, wherein:
the hinge bolt is arranged entirely within a tangent across an outer surface of the cowl aerodynamic surface.

8. The aircraft propulsion system according to claim 1, wherein the hinge line is arranged above an engine center line and perpendicular to a direction of engine thrust.

9. The aircraft propulsion system according to claim 1, wherein the blocker door has a distal end/leading edge that is arranged perpendicular to the thrust direction.

10. The aircraft propulsion system according to claim 1, wherein the cowl includes a nozzle and the thrust reverser is included in the nozzle.

11. The aircraft propulsion system according to claim 1, further comprising:
a controllable actuator that causes the pivot door to be rotated away from a central axis of the engine to be in the reverse position.
